(19) United States
(12) Patent Application Publication
(10) Pub. No.: US 2021/0205826 A1
(43) Pub. Date: Jul. 8, 2021

(54) FAST WATER STOP STRUCTURE

(71) Applicant: RUNNER(XIAMEN) CORP., Xiamen (CN)

(72) Inventors: Gang YU, Xiamen (CN); Lizhong LIAO, Xiamen (CN); Jianbo ZHANG, Xiamen (CN); Shengchao DAI, Xiamen (CN)

(21) Appl. No.: 17/134,822

(22) Filed: Dec. 28, 2020

(30) Foreign Application Priority Data
Jan. 3, 2020 (CN) 202010005440.1

(51) Int. Cl. B05B 1/32; B05B 1/18

(52) U.S. Cl. CPC B05B 1/323; B05B 1/185

(57) ABSTRACT

The present invention discloses a fast water stopping structure, which comprises a body, the body is provided with an internal watercourse, the body is also provided with a water outlet hole connected to the watercourse, the inlet end of the water outlet hole is provided with a water stop plate, the water stop plate is provided with a crack. The structure quickly stops water from the water outlet hole after the water flow is shut off to prevent water from dripping down.

### CROSS-REFERENCE TO RELATED APPLICATIONS 0

This application claims priority to China Patent application No. 202010005440.1 filed Jan. 3, 2020, all of which are hereby incorporated herein in the entireties by reference.

### FIELD AND BACKGROUND OF INVENTION

### 1. Technical Field

The present invention relates to a fast water stop structure, which is suitable for a water outlet device.

### 2. Description of Related Art

At present, existing showerheads and overhead sprays, after being used and shutting off the valve switch, leave some water in the watercourse because of the water flow, and all of this water drips down under its own weight, giving the user a bad experience and causing a degradation of the shower experience.

### BRIEF SUMMARY OF THE INVENTION

To overcome the detects mentioned above, the present invention provides a fast water stop structure.

The present invention is achieved by the following technical solution: A fast water stop structure, which comprises a body, the body is provided with an internal watercourse, the body is also provided with a water outlet hole connected to the watercourse, the inlet end of the water outlet hole is provided with a water stop plate, the water stop plate is provided with a crack.

In an embodiment of the invention, the body comprises an interconnected housing and a water outlet panel, the water outlet panel is provided with a connection hole, the body is provided with a water outlet body internally, the water outlet body is provided with a raised water outlet nozzle, the water outlet nozzle is matched and connected with the connection hole, the water outlet hole is disposed in the water outlet nozzle.

In an embodiment of the invention, a water stop plate is provided in the body at the inlet end of the water outlet nozzle, the water stop plate is provided with a crack corresponding to the inlet end of the water outlet nozzle.

In an embodiment of the invention, the housing is provided with a downwardly projecting first convex ring which is matched and connected to the upper surface of the water stop plate.

In an embodiment of the invention, the water outlet body is provided with a groove on the upper face, and the water stop plate is provided in the groove.

In an embodiment of the invention, the water outlet body is provided with an annular flange around the upper periphery, and the water outlet panel is provided with an upwardly projecting second convex ring, the second convex ring is matched and connected to the lower surface of the annular flange.

In an embodiment of the invention, the crack is a monogram crack.

In an embodiment of the invention, the crack is a cross-shaped crack.

In an embodiment of the invention, the water stop plate is a soft rubber stop plate.

Compared to the prior art, the present invention has the following beneficial effects: 1. The structure can achieve quick water stop and solve the problem of dripping; 2. It can be applied to all shower and overhead spray outlet products, with wide applicability; 3. By making some cracks on the water outlet hole corresponding to the water outlet net made of soft rubber, these cracks will open under the action of water pressure to achieve water outlet, and when the water is turned off with no water pressure, the crack will close again for a quick water stop.

### BRIEF DESCRIPTION OF THE DRAWINGS

In order to more clearly illustrate the technical scheme of the invention, a brief description of the drawings required to be used in embodiments or prior art descriptions will be given below, and it will be apparent that the drawings in the following description are only some examples of embodiments of the invention, and that other drawings may be obtained from these drawings without creative labor on the part of one of ordinary skill in the art.

FIG. 1 is an exploded diagram of the present invention.

FIG. 2 is an exploded view of the present invention.

FIG. 3 is an enlarged diagram at A in FIG. 2.

FIG. 4 is a schematic diagram of an embodiment of the crack in the present invention.

FIG. 5 is a schematic diagram I of another embodiment of cracking in the present invention.

FIG. 6 is a schematic diagram II of another embodiment of cracking in the present invention.

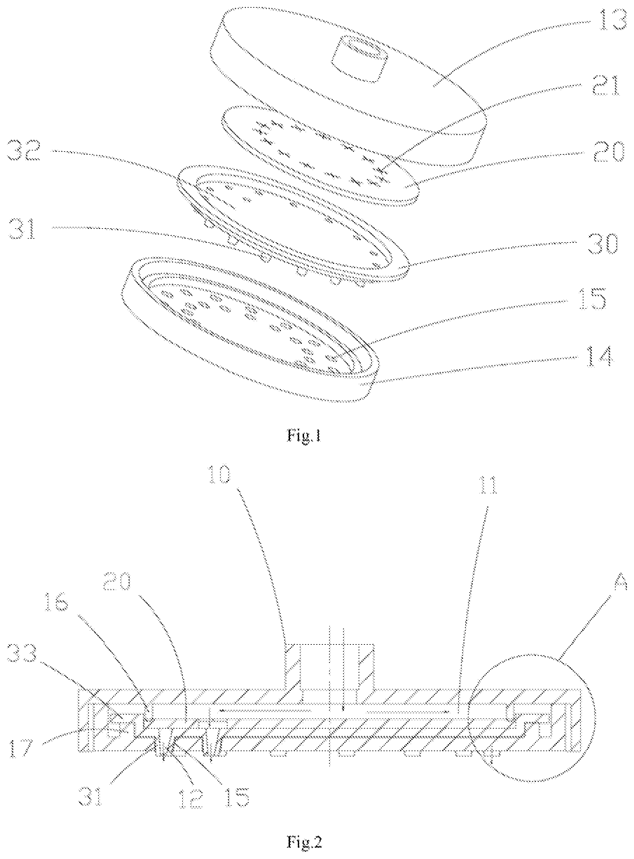

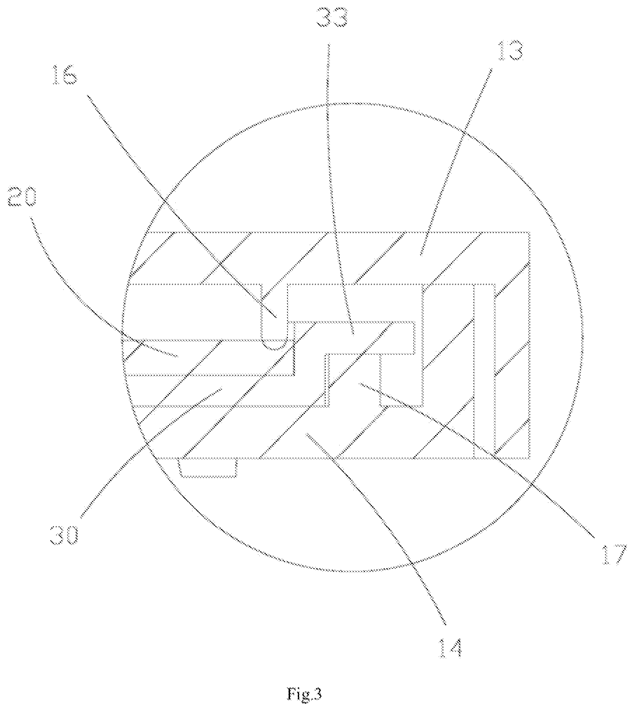

### DESCRIPTION OF THE PREFERRED EMBODIMENTS

The following will provide a clear and complete description of the technical scheme of the present embodiment in conjunction with the drawings in the present embodiment. Obviously, the described embodiments are only a portion of the embodiments of the present invention, but not the entire embodiments. Based on the embodiments of the present invention, all other embodiments obtained by one of ordinary skill in the art without the exercise of inventive labor are within the scope of protection of the present invention.

The term “an example” or “embodiment” as used herein refers to a particular feature, structure, or characteristic that may be included in at least one embodiment of the invention. In the description of the present invention, it is to be understood that the terms “top,” “bottom,” “top,” “bottom,” etc. The directions or position relationships indicated are based on those shown in the drawings and are intended only to facilitate the description of the invention and simplify the description, and are not intended to indicate or imply that the devices or components referred to must have a particular orientation, be constructed and operate in a particular orientation, and therefore are not to be construed as a limitation of the invention. Furthermore, the terms “first” and “second” are used only for descriptive purposes and are not to be understood as indicating or implying a relative importance or implicitly specifying the number of technical features indicated. Thus, a feature that qualifies as “first” or “second” may explicitly or implicitly include one or more such features. Moreover, the terms “first”, “second”, etc. are used to distinguish between similar objects and need not be used to describe a particular order or sequence. It is to be understood that the data so used may be interchangeable where appropriate, so that the embodiments described herein may be practiced in an order other than those illustrated or described herein.

Referring to the drawings accompanying the specification, a fast water stop structure, which comprises a body 10, the body is provided with an internal watercourse 11, the body is also provided with a water outlet hole 12 capable of being connected to the watercourse, the water outlet hole is provided with a water stop 20 at the inlet end, the water stop is provided with a crack 21, in the present invention, water is retained at the inlet end of the body to the overflow and then reaches the stopper, where, because of the water pressure, the flow of water rushes through the cracks and allows the overflow to flow to the outlet hole for discharge, when the valve switch is closed, the municipal water (other water sources are also available) is not flowing into the body; at this time, there is no continuous water flow in the water crossing, and there is no corresponding sufficient water pressure, at this time, the crack closes, so that the water will not flow to the outlet hole, so as to achieve rapid water stop, this prevents water from dripping out of the water outlet after closing the valve. In a better embodiment of the present invention: the waterstop is made of a soft plastic waterstop or an elastic material, that is to say, the waterstop is made of a soft plastic material, which has a certain resilience, and then there is a water flow pressure in order for water to break through the crack, so that the waterstop can form an opening at the crack where water can pass, and when there is no water flow pressure, the waterstop closes again at the crack and does not allow water to flow through the waterstop.

Preferably, the body comprises an interconnected housing 13 and a water outlet panel 14, the water outlet panel is provided with a connection hole 15, the body is provided with a water outlet body 30, the water outlet body is provided with a raised water outlet nozzle 31, the water outlet nozzle is connected in conjunction with the connection hole, the water outlet hole is provided within the water outlet nozzle, and in the present invention, the water outlet body is provided with a number of water outlet nozzles, which can be arranged on the water outlet body in the form of circular distribution, and the connecting holes are also arranged on the water outlet panel according to the distribution of the water outlet nozzles, so as to realize one-to-one correspondence between the connection holes and the water outlet nozzles, and insert one end of the water outlet nozzles into the connection holes. A water stop plate is arranged in the main body at the inlet end of the water outlet nozzle. The water stop plate is provided with a crack corresponding to the water inlet end of the water outlet nozzle. The same crack and the water outlet nozzle can also be the same corresponding. A crack is set at the water inlet end of each water outlet nozzle, so that when the water is flowing, each crack does not rush open, and then spray from the water outlet nozzle.

More specifically: the housing is provided with a downwardly projecting first convex ring 16, the first convex ring is matched and connected to the upper end of the water stop. The upper surface of the water outlet body is provided with a groove 32, and the water stop plate is disposed within the groove. The water outlet body is provided with an annular flange 33 on the upper periphery, and the water outlet panel is provided with an upwardly projecting second convex ring 17, the second convex ring is matched and connected to the lower end face of the annular flange. In the present invention, the first convex ring exerts a downward action on the water outlet body and the water stop plate, which presses the water stop plate down to keep it in the groove and also ensures a stable connection between the water out body and the water out panel, and the second convex ring exerts an upward reaction on the water outlet body and the water stop plate so that both are better fixed in the body, and the second convex ring can be matched and connected with the outer peripheral wall of the water out body, so as to achieve the connection of the water out body to the water out panel, the stability of the water stop axially and longitudinally.

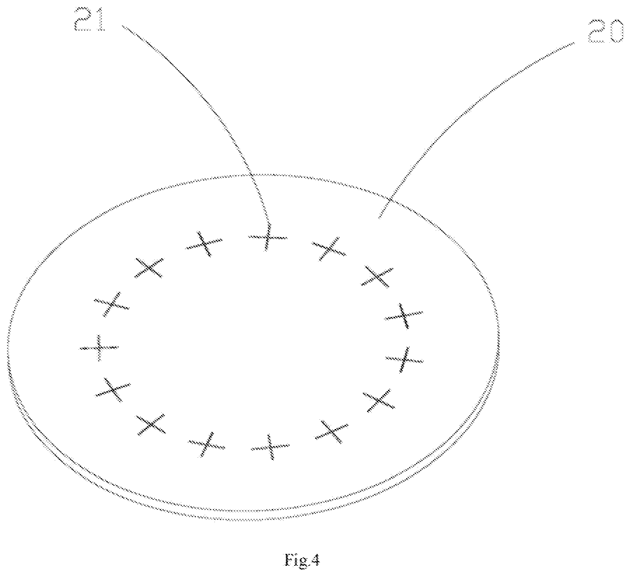

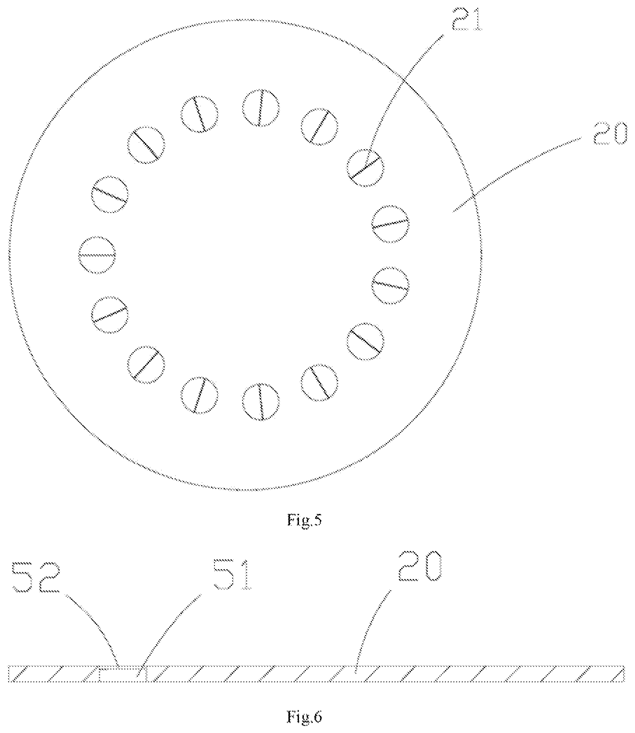

In one embodiment of the present invention: the crack is a cross-shaped crack, with reference to FIG. 4 of the accompanying specification; in another embodiment: the crack is a one-shape crack, with specific reference to FIGS. 5 and 6 of the accompanying specification, and more specifically: a hole 51 is made at the water stop corresponding to the water inlet end of the water outlet nozzle, and then a thin sheet 52 is used on the hole, and a further crack is made in the sheet, the thickness of the sheet is no greater than the thickness of the water stop plate may be described by reference to the drawings accompanying the specification.

The foregoing statements expressly state and describe preferred embodiments of the invention and, as previously stated, it is to be understood that the invention is not limited to the form disclosed herein and should not be considered to the exclusion of other embodiments, but may be used in a variety of other combinations, modifications, and environments and is capable of being altered within the scope of the inventive concept described herein by the above teachings or the skill or knowledge of those in the related field. And the alterations and changes made by persons in the art which do not depart from the spirit and scope of the invention shall be within the protection of the claims appended hereto.

1. A fast water stop structure, wherein it comprises a body, the body is provided with an internal watercourse, the body is also provided with a water outlet hole connected to the watercourse, the inlet end of the water outlet hole is provided with a water stop plate, the water stop plate is provided with a crack.

2. A fast water stop structure according to claim 1, wherein the body comprises an interconnected housing and a water outlet panel, the water outlet panel is provided with a connection hole, the body is provided with a water outlet body internally, the water outlet body is provided with a raised water outlet nozzle, the water outlet nozzle is matched and connected with the connection hole, the water outlet hole is disposed in the water outlet nozzle.

3. A fast water stop structure according to claim 2, wherein a water stop plate is provided in the body at the inlet end of the water outlet nozzle, the water stop plate is provided with a crack corresponding to the inlet end of the water outlet nozzle.

4. A fast water stop structure according to claim 3, wherein the housing is provided with a downwardly projecting first convex ring which is matched and connected to the upper surface of the water stop plate.

5. A fast water stop structure according to claim 4, wherein the water outlet body is provided with a groove on the upper face, and the water stop plate is provided in the groove.

6. A fast water stop structure according to claim 5, wherein the water outlet body is provided with an annular flange around the upper periphery, and the water outlet panel is provided with an upwardly projecting second convex ring, the second convex ring is matched and connected to the lower surface of the annular flange.

7. A fast water stop structure according to claim 1, wherein the crack is a monogram crack.

8. A fast water stop structure according to claim 1, wherein the crack is a cross-shaped crack.

9. A fast water stop structure according to claim 1, wherein the water stop plate is a soft rubber stop plate.

10. A fast water stop structure according to claim 7, wherein the body comprises an interconnected housing and a water outlet panel, the water outlet panel is provided with a connection hole, the body is provided with a water outlet body internally, the water outlet body is provided with a raised water outlet nozzle, the water outlet nozzle is matched and connected with the connection hole, the water outlet hole is disposed in the water outlet nozzle.

11. A fast water stop structure according to claim 7, wherein a water stop plate is provided in the body at the inlet end of the water outlet nozzle, the water stop plate is provided with a crack corresponding to the inlet end of the water outlet nozzle.

12. A fast water stop structure according to claim 7, wherein the housing is provided with a downwardly projecting first convex ring which is matched and connected to the upper surface of the water stop plate.

13. A fast water stop structure according to claim 7, wherein the water outlet body is provided with a groove on the upper face, and the water stop plate is provided in the groove.

14. A fast water stop structure according to claim 7, wherein the water outlet body is provided with an annular flange around the upper periphery, and the water outlet panel is provided with an upwardly projecting second convex ring, the second convex ring is matched and connected to the lower surface of the annular flange.

15. A fast water stop structure according to claim 8, wherein the body comprises an interconnected housing and a water outlet panel, the water outlet panel is provided with a connection hole, the body is provided with a water outlet body internally, the water outlet body is provided with a raised water outlet nozzle, the water outlet nozzle is matched and connected with the connection hole, the water outlet hole is disposed in the water outlet nozzle.

16. A fast water stop structure according to claim 8, wherein a water stop plate is provided in the body at the inlet end of the water outlet nozzle, the water stop plate is provided with a crack corresponding to the inlet end of the water outlet nozzle.

17. A fast water stop structure according to claim 8, wherein the housing is provided with a downwardly projecting first convex ring which is matched and connected to the upper surface of the water stop plate.

18. A fast water stop structure according to claim 8, wherein the water outlet body is provided with a groove on the upper face, and the water stop plate is provided in the groove.

19. A fast water stop structure according to claim 8, wherein the water outlet body is provided with an annular flange around the upper periphery, and the water outlet panel is provided with an upwardly protective second convex ring, the second convex ring is matched and connected to the lower surface of the annular flange.

20. A fast water stop structure according to claim 9, wherein the body comprises an interconnected housing and a water outlet panel, the water outlet panel is provided with a connection hole, the body is provided with a water outlet body internally, the water outlet body is provided with a raised water outlet nozzle, the water outlet nozzle is matched and connected with the connection hole, the water outlet hole is disposed in the water outlet nozzle.

21. A fast water stop structure according to claim 9, wherein a water stop plate is provided in the body at the inlet end of the water outlet nozzle, the water stop plate is provided with a crack corresponding to the inlet end of the water outlet nozzle.

22. A fast water stop structure according to claim 9, wherein the housing is provided with a downwardly projecting first convex ring which is matched and connected to the upper surface of the water stop plate.

23. A fast water stop structure according to claim 9, wherein the water outlet body is provided with a groove on the upper face, and the water stop plate is provided in the groove.

24. A fast water stop structure according to claim 9, wherein the water outlet body is provided with an annular flange around the upper periphery, and the water outlet panel is provided with an upwardly projecting second convex ring, the second convex ring is matched and connected to the lower surface of the annular flange.
